(19) United States
(12) Patent Application Publication
(10) Pub. No.: US 2006/0059364 A1
(43) Pub. Date: Mar. 16, 2006

(54) Bio-linking a user and authorization means

(75) Inventor: Wilhelmus Franciscus Johannes Fontijn, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/536,232

(22) PCT Filed: Oct. 31, 2003
(86) PCT No.: PCT/IB03/04910

§ 371 Date: May 24, 2005

(30) Foreign Application Priority Data
Nov. 28, 2002 (EP) 02079979.7

(51) Int. Cl. H04L 9/32

(52) U.S. Cl. 713/186; 726/2

(57) ABSTRACT

The invention relates to a system (100) for authorizing a user (111) to use a device requiring authorization (140), and a method of authorizing a user to use such a device. The system comprises identification means (130) arranged to identify the user, authorization means (120, 320) arranged to authorize the user to use said device requiring authorization, at least one linking means (110) arranged to establish and monitor a bio-link between the user and the authorization means, and at least one linking means being further arranged to activate said authorization means in response to a valid user identification by the identification means. Said authorization means (120) is active only while said link is valid.

The invention relates to a system for authorizing a user to use a device requiring authorization, the system comprising authorization means arranged to authorize the user to use said device, and a method of authorizing a user to use such a device.

Document U.S. Pat. No. 5,461,812 discloses a method of protecting a weapon, e.g. a gun, from being used by an unauthorized person. A system features a finger ring that must be worn on the finger of a weapon owner. Whenever the ring is placed on the finger, an enabling apparatus stored in a secure location, has to be used for sending a signal to both the weapon and the ring. In use, the signal stored in the ring is transmitted to the weapon, the transmitted signal is compared with the signal stored in the weapon to allow the person with the ring to operate the weapon. The person having the ring can use the weapon. The ring has a switch mechanism to detect whether the ring is worn on the user's finger, by providing a switch closure.

However, one can remove the ring without releasing the switch, e.g. by jamming something in the ring. In that way, the unauthorized person may use the ring, i.e. the authorization means, and pretend to be authorized for using the weapon. The method known in the prior art is not sufficiently secure.

It is an object of the present invention to obviate the drawback of the prior art system, and to provide a method and system for more secure authorization.

The object of the invention is realized in that the system for authorizing the user to use the device requiring authorization comprises

identification means arranged to identify the user,

authorization means arranged to authorize the user to use said device requiring authorization,

at least one linking means arranged to establish and monitor a bio-link between the user and the authorization means, and

at least one linking means being further arranged to activate said authorization means in response to a valid user identification by the identification means,

said authorization means being active only while said link is valid.

After at least one linking means establishes the bio-link between the user and the authorization means, the link is monitored to ensure that the link is valid, e.g. that the authorization means is attached to the user. The authorization means may be activated if the user has proved his identity by using the identification means. The authorization means may be active as long as the bio-link is valid. Once the authorization means is active, it can be used for authorizing the user to use at least one device requiring authorization, instead of asking a direct input from the user.

The system features a presence of the bio-link between the user and the authorization means. The bio-link allows to determine reliably whether the authorization means is in possession of the authorized user. Otherwise, any person might use the authorization means. The bio-link may be based on continuous measurements of parameters pertaining to the user, for example, biometric parameters, which are very difficult to falsify without breaking the uninterrupted link, for example, breathing sound, heart rate, etc.

In that way, the invention allows the user to avoid safely the procedure of proving his identity to the device requiring authorization whenever the user would like to use it. The invention provides a very secure way of preventing the need for recurring authorization without being obtrusive or invasive.

If there are many linking means, the authorization means may be activated by any one of them if the bio-link is valid and the user is identified by the identification means as the authorized person.

The device requiring authorization may be arranged to require an access code, i.e. identification data, for allowing the user to use it. The system may be arranged in such a way that the authorization means obtains the code from the identification means upon the valid user identification and, of course, if the bio-link is valid, then the authorization means may deliver the obtained code to the device requiring authorization.

The biometric measurements of parameters obtained by the linking means may be used by the identification means for user identification by comparing a value of one or more parameters with stored identification data. Thus, the system always correctly recognizes the user if the used biometric data, e.g. an iris scan, finger print, are unique, for human beings.

Alternatively, the authorization means may be arranged to use the biometric measurements obtained by the linking means in lieu of said access code. The access code may be basically transmitted using encryption techniques, which does not hamper the correct authorization of the user to use the devices requiring authorization.

The object of the invention is also realized in that the method of authorizing the user to use the device requiring authorization, comprises

a step of identifying the user,

a step of establishing and monitoring a bio-link between the user and authorization means arranged to authorize the user to use said device requiring authorization,

a step of activating said authorization means in response to a valid user identification,

said authorization means being active only while said link is valid.

The steps of the method of the present invention elucidate the operation of the system as described above.

These and other aspects of the invention will be further elucidated and described with reference to the accompanying drawings, wherein:

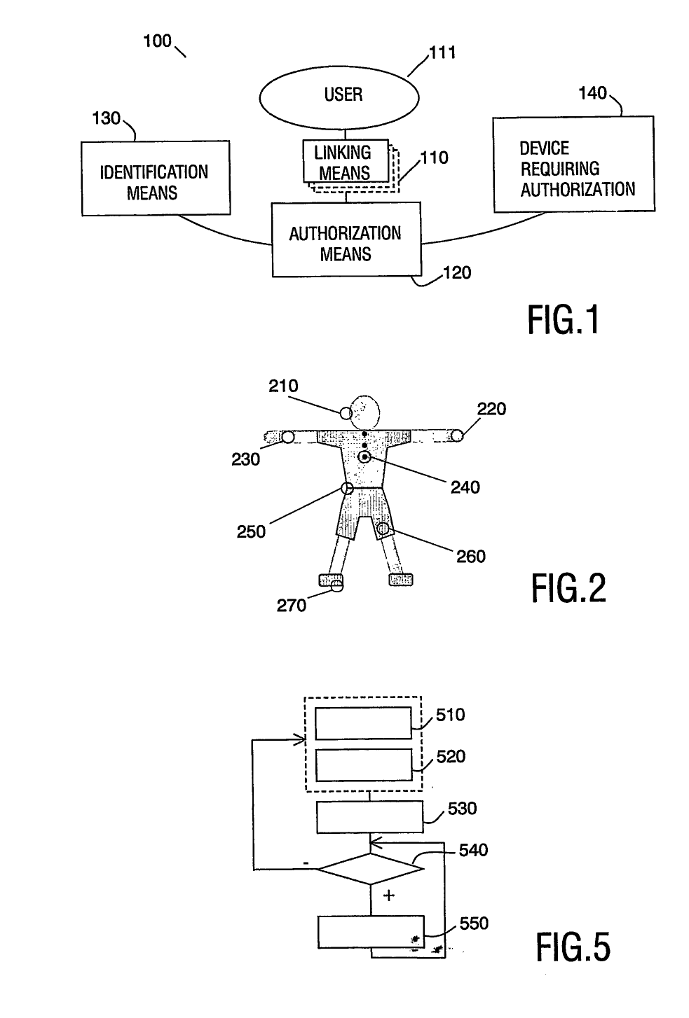

FIG. 1 shows a functional block diagram of the system suitable for implementing the present invention;

FIG. 2 shows an embodiment of the system according to the present invention, in which the examples of linking means arranged to establish and monitor the bio-link are given;

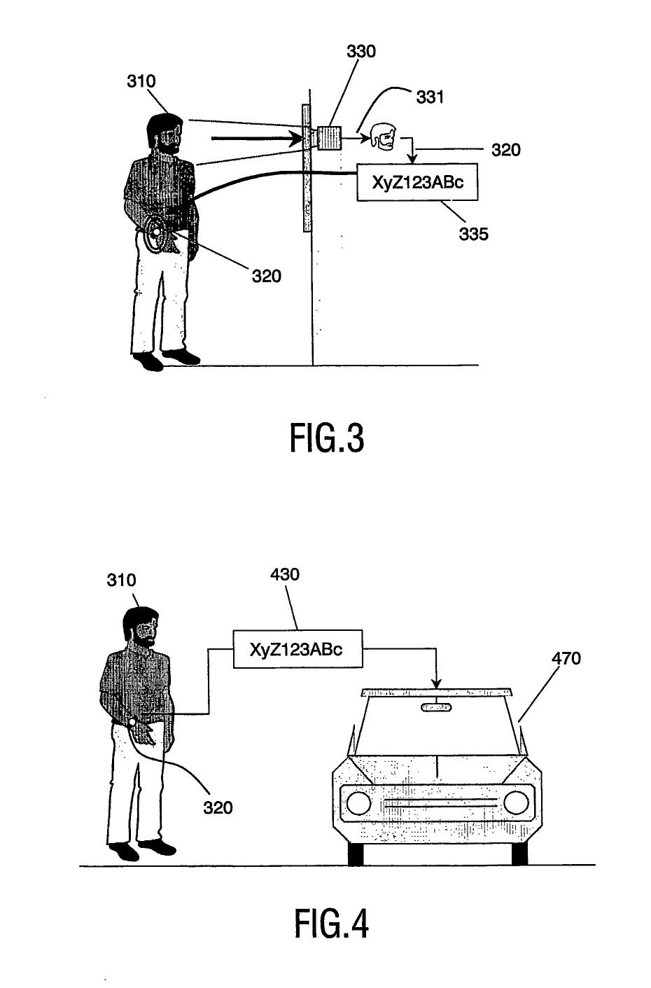

FIG. 3 shows an embodiment of the system according to the present invention, in which the identification means, authorization means and linking means are illustrated;

FIG. 4 shows an embodiment of the system according to the present invention, in which authorizing the user to use the device requiring authorization, with the aid of the authorization means, is illustrated;

FIG. 5 shows an embodiment of the method according to the present invention.

FIG. 1 shows an embodiment of the system 100 according to the present invention, comprising at least one linking means 110, further referred to as bio-sensor, authorization means 120, identification means 130 and a device requiring authorization 140.

The bio-sensor 110, i.e. linking means, is arranged to establish and monitor a bio-link between a user 111 and the authorization means 120 (or an authorization unit). The authorization unit 120 is arranged to authorize the user 111 to use the device requiring authorization 140. The identification means 130 (or identification unit) is arranged to identify the user 111. The device requiring authorization 140 may be the device which requires the authorization to use it.

When the bio-link is established between the user and the authorization unit and the user is validly identified by the identification unit, the bio-sensor may activate the authorization unit so that the user is able to use the device requiring authorization as long as the bio-link is valid. Of course, it is more secure to activate the authorization unit after it is certain that the user is genuine, i.e. identified, and the authorization unit is “attached” to the user, i.e. the bio-link is valid. However, the authorization unit maybe activated upon establishing the bio-link without the user identification, for example, if the system is arranged to determine that the user is the same person, e.g. because he is alone in a room and did not leave the room. Other deviations from the described system are possible.

The bio-sensor 110 can determine whether the user is in possession of the authorization unit by monitoring the bio-link between the user and the authorization unit. Using the bio-link, the system can authentically determine that nobody else but only the identified, i.e. intended, user exploits the authorization unit which in turn allows the user to use the device requiring authorization.

The bio-link between the user and the authorization unit, established by the bio-sensor, may be related to some biological function pertaining to the user as a living entity. This biological characteristic may be continuous, i.e. substantially the same or slightly vary as long as the user is in a normal physical condition. The bio-sensor may be arranged to monitor, e.g. to sense at least one of such characteristics. As long as the sensed characteristic can be sensed and/or varies within some bounds, it may be assumed that the bio-link is not interrupted and valid. If the bio-link is broken for some period of time, it may mean that the authorization unit is no longer attached to the authorized user.

Since the authorization unit is arranged to identify the user to the device requiring authorization, the user is not bothered by requests from this device to authorize him. In this way, the system provides a very secure way of recurring authorization of the user to the device requiring authorization.

The bio-sensor may be arranged to measure at least one biometric parameter such as a temperature, breathing sound, heart rate, electrical potential, etc.

Some examples of the bio-sensor are given with reference to FIG. 2. The bio-sensor may be arranged to measure the potential 210 over the pin through the earlobe. The bio-sensor may be arranged to de-activate the authorization unit if one or many measured parameters exceed at least one predetermined threshold. As long as the potential remains contiguous within certain values, the earring is considered to be attached to the ear. The bio-sensor may be arranged to notify the user, e.g. in the form of alarm, that the bio-link is broken.

The bio-sensor may be a ring 220 arranged to measure the heartbeat in the finger. As long as the rate shows no severe discontinuities, the ring is considered to be around the finger of the user.

In another example, the bio-sensor may be a wrist watch 230 arranged to measure the temperature at the watch/wrist interface. In a further example, a device 240, e.g. a belly button, may be arranged to sense the sound of breathing. In a further example, a device 250 located at the hem may be arranged to measure a combination of temperature and light levels. In a further example, the bio-sensor 260 may be a patch arranged to measure the resistivity of the skin. In a further example, the bio-sensor 270 may be arranged to measure humidity inside the shoe. In a further example, the bio-sensor may be a wearable computing device such as a personal digital assistant (PDA) arranged to measure contact current. Yet, in further examples, the bio-sensor may be attached to a tongue of the user by piercing it, or the bio-sensor may be a swallowed capsule or a belt buckle, etc.

It should be noted that the authorization unit and/or the bio-sensor do(es) not necessarily have to be in physical contact with the user's body.

More than one bio-sensor may be included into the system 100. The system may comprise more than one bio-sensor arranged to sense the same biometric characteristic. The measurements of the characteristic may be further related, e.g. averaged, or the bio-link may be considered valid as long as at least one of the measurements is admissible.

The identification of the user by the identification unit, and activation of the authorization unit may be done in many ways. The identification unit may acquire user data from the user and compare them with identification data stored in the system. The user may be required by the identification unit to input the user data, or the user may initiate the input himself. In one of the embodiments of the present invention, the identification unit may comprise a camera behind the dressing mirror, capturing the features of the face of the person, i.e. the user, standing in front of it. The detected features of the user are subsequently matched with those on store in the system. In another example, the identification unit may be a terminal at which an identifying password needs to be entered. In a further example, the identification unit may comprise a touch-sensitive covering on top of some device, e.g. the watch, said covering being arranged to sense a finger print. In a further example, the identification unit may comprise a scanning device acquiring the user data by scanning the user body when the user goes through a portal, e.g. the front door. In a further example, the user has to stare directly at a camera for an iris scan.

In one of the embodiments, the identification unit may comprise input/output means arranged to interactively communicate with the user to identify him. The identification unit may be arranged to obtain certain biometric measurements pertaining to the user, such as the finger print or a voice recognition. In one example, the identification unit may communicate to the user a request to confirm that he is a user N.N. If the user inputs an affirmative reply, the identification unit may compare the obtained biometric measurements of that user with user identification data in a database stored in the system. If the measurements and the user identification data are different, the identification unit may refuse to authenticate the user as the user N.N., and a more robust or secure identification procedure(s) may be initiated.

The authorization unit according to the present invention may be embodied in different manners. The authorization unit may comprise a wireless communication unit for communicating identification data to the device requiring authorization. The identification data may be data necessary to authorize the user to the device requiring authorization. Said identification data may be delivered to this device by using the well-known “Bluetooth” technology. In another example, a direct contact such as a wired connection may be used to deliver the identification data.

There may be many ways of authorizing the user to use the device requiring authorization. For example, the identification unit may store identification data which are necessary for the authorization of the user to the correspondent device requiring authorization. The authorization unit may deliver the identification data to the device requiring authorization. In another example, the authorization unit itself may be used for identifying the user to the correspondent device requiring authorization if said authorization unit is activated by the bio-sensor.

In one of the embodiments of the present invention, the identification unit and authorization unit may be included in one device, so that no transmission of the identification data is needed.

According to au embodiment of the present invention, the authorization unit and the bio-sensor may be implemented in one device. In this case, the activation of the authorization unit may be realized in a simple way. If the authorization unit and the bio-sensor are not incorporated in one device, there may be a need to secure the transmission of an activation signal from the bio-sensor to the authorization unit, for example, by using encoding techniques to encode an activation code for activating the authorization unit.

In a further embodiment, the system may comprise many bio-sensors, each of which is capable of activating the authorization unit upon establishing the valid bio-link and valid user identification.

In a further embodiment, the system may comprise more than one authorization unit. Each authorization unit may need to obtain a valid bio-link between a particular authorization unit and the user, established and monitored by the bio-sensor. Once one of a plurality of the authorization units receives information that the user is identified by the identification unit, all authorization units having valid bio-links may be activated.

Any authorization unit having the valid bio-link may obtain the identification data from the authorization unit which has the valid bio-link and has already obtained the identification data from the identification unit. In this way, any subsequent authorization unit having the valid bio-link may not always need separate identification but can obtain its identification data from the bio-linked authorization unit that has already received the identification data. Thus, if the bio-link between one of the authorization units and the user is temporarily lost, e.g. for a small period of time such as several seconds, the user may not need to be identified again by the identification unit.

In one of the embodiments, several authorization units may need only one bio-sensor and therefore only one bio-link. Such authorization units having the same bio-link may be arranged to authorize the user to use different devices requiring authorization. These authorization units may correspondingly need to obtain different identification data for the respective devices requiring authorization. The identification unit may store such different identification corresponding to the respective devices requiring authorization.

After the identification data are delivered to the device requiring authorization, the device may compare the identification data with the authorization data stored in the device requiring authorization. If the data are identical, the user may be permitted to use the device. The device requiring authorization may be any device capable of verifying the identification data delivered to it by the authorization unit to let the user use this device. Such a device requiring authorization may be incorporated in a consumer electronics device such as PDA, PC, television set, etc, automobiles and other apparatuses. Of course, mere than one device requiring authorization may be used by the authorized user.

FIG. 3 shows the identification unit 330 arranged to identify the user 310, the authorization unit and the bio-sensor arranged in the form of a wrist watch 320.

FIG. 3 illustrates activation of the authorization unit 320. The user 310 has put on his wrist watch 320 comprising the authorization unit according to the invention, which happens to be temperature-sensitive. The authorization unit 320 is tied to the user 310 using the bio-sensor by establishing a continuous link, i.e. the bio-link, based on the temperature at the watch/wrist interface. Before the user 310 goes out, he may check his hair. In doing so, the user may offer his face to the identification unit 330 comprising a camera. The camera maybe arranged to acquire an image of the user's face 331 for a subsequent recognition 332 by the identification unit. If the user is recognized by the identification unit, the identification unit may send the activation signal for activating the authorization unit to the bio-sensor comprised in the watch 320.

The identification unit may be arranged to store the identification data including a code 335 associated with a particular user, and to retrieve the identification data corresponding to the user upon said recognition 332. Furthermore, the identification unit may be arranged to send the identification information 335 to the authorization unit. The authorization unit 320 may comprise a memory for storing the identification information which may be erased if the bio-link between the user and the authorization unit 320 is lost. If the identification information is erased, the authorization unit may need to be activated again.

The authorization unit may be used to identify the user to the device requiring authorization by delivering the identification information 335 to said device. It is an advantage of the present invention that after the activation of the authorization unit 320, the means 320 may be used instead of requiring direct input from the user.

FIG. 4 illustrates authorizing the user 310 to use the device requiring authorization 470, wherein it is assumed that the authorization unit 320 has been activated. The user 310 approaches the car 470, i.e. the device requiring authorization. His wrist watch 320, being temperature-sensitive, may be used to identify him to the car 470. The authorization unit 320 may transmit to the car the identification code 430 which may be the same or related to the identification information 335 mentioned with reference to FIG. 3. Then, the car may unlock the doors, configure the driver seat to user's preferences, switch a radio in the car to a user's favorite station, etc.

FIG. 5 shows an embodiment of the method of the present invention. In step 510, the bio-sensor 110 may establish the bio-link between the user 111 and the authorization unit 120. In step 520, the identification unit 130 may identify the user 111. If the user is identified and the valid bio-link is obtained, the bio-sensor activates said authorization unit 120 in step 530. In step 540, the bio-sensor monitors whether the established bio-link is valid. After said activation, the authorization unit may be used to authorize the user to use the device requiring authorization 140 in step 550, if the bio-link is valid. If the bio-link is not valid, the identification and/or re-establishing of the bio-link may be needed. The method of the present invention describes the operation of the system as disclosed above. Further embodiments of the method, corresponding to the embodiments of the system of the present invention described above, may be derived therefrom.

In one of the embodiments of the present invention, the television set, video recorder or other consumer electronics device may be arranged to require authorization for using it. The remote control unit, keyboard, trackball, mouse or other user input device arranged to control such a consumer electronics device may incorporate the authorization unit and/or the bio-sensor as described above. In a further embodiment, said user input device may also comprise the identification unit. For example, the remote control unit may be provided with a touch-sensitive screen adapted to acquire the user finger print for identifying the user. The remote control unit may also be provided with a sensor for sensing whether the user is in proximity of the control unit, so that the remote control unit may be made personal to a particular user. Such a remote control unit may be designed to be very easy to use, for example, in the form of a bracelet.

The various program products may implement the functions of the device and method of the present invention and may be combined in several ways with the hardware or located in different other devices. Variations and modifications of the described embodiment are possible within the scope of the inventive concept. Thus, for example, the use of the verb ‘to comprise’ and its conjugations does not exclude the presence of elements or steps other than those defined in a claim. The invention can be implemented by means of hardware comprising several distinct elements, and by means of a suitably programmed computer. In the device claim enumerating several means, several of these means can be embodied by one and the same item of hardware.

1. A system (100) for authorizing a user (111) to use a device requiring authorization (140), the system comprising:
identification means (130) arranged to identify the user,
authorization means (120, 320) arranged to authorize the user to use said device requiring authorization,
at least one linking means (110) arranged to establish and monitor a bio-link between the user and the authorization means, and
at least one linking means (110) being further arranged to activate said authorization means in response to a valid user identification by the identification means,
said authorization means (120, 320) being active only while said link is valid.

2. The system of claim 1, wherein the authorization means is arranged to be activated by any one of a plurality of said linking means.

3. The system of claim 1, wherein the authorization means is arranged to obtain from the identification means identification data (335) and to deliver said identification data to the device requiring authorization.

4. The system of claim 1, wherein the linking means (210, 220, 230, 240, 250, 260, 270) is arranged to measure at least one biometric parameter pertaining to said user.

5. The system of claim 4, wherein the linking means is arranged to de-activate said authorization means if at least one parameter exceeds at least one predetermined threshold.

6. The system of claim 4, wherein the identification means is arranged to obtain a value of at least one parameter measured by the linking means, and to compare said value with identification data stored in the system.

7. The system of claim 4, wherein the biometric parameter pertaining to the user is selected from a group of temperature, breathing sound, heart rate, electrical potential.

8. The system of claim 1, comprising a plurality of the authorization means.

9. The system of claim 8, wherein a first authorization means is arranged to obtain identification data from a second authorization means which has obtained said identification data, said identification data being used to authorize the user to use said device requiring authorization.

10. A method of authorizing a user to use a device requiring authorization, the method comprising:
a step (520) of identifying the user,
a step (510) of establishing and monitoring a bio-link between the user and authorization means arranged to authorize the user to use said device requiring authorization,
a step (530) of activating said authorization means in response to a valid user identification,
said authorization means being active only while said link is valid.

11. A computer program product enabling a programmable device when executing said computer program product to function as the system as defined in claim 1.
